(19) United States
(12) Patent Application Publication
(10) Pub. No.: US 2009/0130527 A1
(43) Pub. Date: May 21, 2009

(54) PLANAR FUEL CELL HAVING CATALYST LAYER WITH IMPROVED CONDUCTIVITY

(75) Inventors: Gerard F. McLean, West Vancouver (CA); Jeremy Schrooten, Mission (CA)

Correspondence Address: SCHWEGMAN, LUNDBERG & WOESSNER, P.A., P.O. BOX 2938, MINNEAPOLIS, MN, 55402, US

(73) Assignee: Angstrom Power Incorporated, North Vancouver (CA)

(21) Appl. No.: 12/275,020

(22) Filed: Nov. 20, 2008

Related U.S. Application Data
(60) Provisional application No. 60/989,748, filed on Nov. 21, 2007.

(51) Int. Cl. H01M 8/10; H01M 4/88

(52) U.S. Cl. 429/33; 502/101; 977/742

(57) ABSTRACT

The performance of solid polymer electrolyte fuel cells having planar architecture is improved by increasing the electrical conductivity in at least one of the catalyst layers. The conductivity is increased by incorporating a highly electrically conductive additive selected from the group consisting of graphite, carbon nanotubes, and corrosion tolerant metals.

### PRIORITY OF INVENTION

This non-provisional application claims the benefit of priority under 35 U.S.C. §119(e) to U.S. Provisional Patent Application Ser. No. 60/989,748, filed Nov. 21, 2007, which is herein incorporated by reference.

### TECHNICAL FIELD

The invention relates to improvements for planar solid polymer electrolyte fuel cells. In particular it relates to constructions and methods for increasing the electrical conductivity of the catalyst layers in the fuel cell.

### BACKGROUND

Performance losses in fuel cells can generally be attributed to kinetic losses associated with catalytic activity, ohmic losses resulting from current flow through materials with low conductivity and/or high contact resistance at material interfaces, and mass transfer from insufficient reactant availability.

Planar fuel cells generally suffer from relatively high ohmic losses. Unlike bipolar architectures, planar fuel cells conduct current from reaction sites within the electrode active area to current collectors coupled to the edge of the electrodes. For this reason, current collectors should be spaced relatively close to one another in planar fuel cells in order to reduce losses resulting from longer in-plane conduction paths. However, these dimensional constraints limit the available electrode active area space.

### SUMMARY

Embodiments of the invention relate to a planar fuel cell system including a plurality of solid polymer electrolyte fuel cells arranged in a planar architecture, each fuel cell including an anode electrode, a cathode electrode, and a solid polymer electrolyte. Each electrode includes a catalyst layer. The system also includes current collectors coupled to at least one edge of an electrode. At least one of the anode and cathode catalyst layers includes a highly electrically conductive additive.

### BRIEF DESCRIPTION OF THE DRAWINGS

In the drawings, like numerals describe similar components throughout the several views. Like numerals having different letter suffixes represent different instances of similar components. The drawings illustrate generally, by way of example, but not by way of limitation, various embodiments discussed in the present document.

FIG. 1 is an illustration of an exemplary embodiment of a fuel cell in the system.

FIG. 2 is an illustration of through-plane and in-plane dimensions of a fuel cell system.

### DESCRIPTION

The Detailed Description includes references to the accompanying drawings, which form a part of the Detailed Description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated.

In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Conventional fuel cells utilize bipolar plates (also known as separator plates) to collect current produced by the fuel cell. These bipolar plates are typically arranged parallel to membrane electrode assemblies (MEAs), in a ‘stacked’ or layered configuration. Such fuel cells use gas diffusion layers both to enable reactant distribution to each fuel cell and to enhance electrical conductivity in a direction perpendicular to the plane of the MEA.

Planar, ‘edge collected’ fuel cells generally suffer from relatively high ohmic losses due to the need to transfer electrons “in-plane” along the electrodes to the edge of each fuel cell, where current is collected. This inherently constrains the maximum size of active area of planar fuel cells so that ohmic losses do not excessively impact performance of the system. One way to increase the allowable electrode active area space between the current collectors is to lower the in-plane resistance (i.e. increase the conductivity) between the current collectors. Some planar fuel cell systems attempt to address this issue through use of gas diffusion layers disposed on top of the electrodes to improve conductivity; however, this solution requires external compression in order to maintain contact between the electrodes and the gas diffusion layer, which contributes to the overall ‘balance of plant’ of the system, negatively impacting energy density.

The present invention relates to a planar solid polymer electrolyte fuel cell system having improved electrical conductivity in the electrode catalyst layers. This may be achieved by incorporating a highly electrically conductive additive in at least one of the anode and cathode catalyst layers. The electrically conductive additive may comprise graphite, carbon nanotubes, corrosion tolerant metals, or combinations thereof. Improving the catalyst layer conductivity in turn improves the performance of the planar fuel cell system.

### Definitions:

As used herein, “fuel cell” refers to a device that converts chemical energy to electrical energy through an electrochemical reaction. Any suitable type of fuel cell and appropriate materials can be used according to the present invention including without limitation proton exchange membrane fuel cells (PEMFCs), solid oxide fuel cells (SOFCs), molten carbonate fuel cell (MCFCs), alkaline fuel cells, other suitable fuel cells, and materials thereof. Further examples of fuel cells include direct methanol fuel cells, direct borohydride fuel cells, and phosphoric acid fuel cells. Fuel cells may utilize any number of different reactants as fuel, including but not limited to hydrogen, methanol, ethanol, butane, formic acid, borohydride compounds (including sodium borohydride and potassium borohydride),

As used herein, “planar fuel cell array” refers to one or more fuel cells configured to form an array that includes individual fuel cells that are arranged substantially two-dimensionally in any of various suitable ways on an area covered by the array. For example, active regions of individual fuel cells may be arranged to provide columns of substantially parallel stripes, or shapes distributed at nodes of a two-dimensional lattice configuration, which may be a rectangular, square, triangular or hexagonal lattice, for example, and which is not necessarily completely regular. A pattern of shapes distributed in both a width and a length dimension of the area covered by the array may be provided, such that a pattern may be less regular than a lattice-type pattern, for example. Thin layer fuel cells may be arranged into arrays constructed of very thin layers. Within such an array, individual unit fuel cells may be coupled in a series or series-parallel arrangement. Coupling fuel cells in such an arrangement may permit electrical power to be delivered from an array of fuel cells at increased voltages and reduced currents. The planar fuel cell array may be formed using a flexible sheet which is thin in one dimension and which supports a number of electrochemical cells. The fuel cells may have active areas of one type (e.g. cathodes) that are accessible from one face of the sheet and active areas of another type (e.g. anodes) that are accessible from an opposed face of the sheet. The active areas may be disposed to lie within areas on their respective faces of the sheet (e.g. it is not mandatory that the entire sheet be covered with active areas, however, the performance of a fuel cell may be increased by increasing its active area).

Examples of such planar fuel cell arrays can be found in commonly-owned U.S. Patent Application 2005/0250004, entitled “Electrochemical cells having current-carrying structures underlying electrochemical reaction layers”, the disclosure of which is herein incorporated in its entirety by reference.

A planar fuel cell array may be substantially flat or level, or may have a curvature imparted to it. A planar fuel cell array may be flexible. As used herein, “flexible” refers to a layer or component that may be deformed, bent, flexed or plied. Fuel cell layers, arrays, composite layers, or components may be partially or substantially flexible in one or more directions. A flexible fuel cell layer may be flexible in whole or in part, so-as-to embrace, for example, a fuel cell layer having one or more rigid components integrated with one or more flexible components. Examples of flexible fuel cell layers can be found in commonly-owned U.S. patent application Ser. No. 12/238,241, entitled “Fuel cell systems including space-saving fluid plenum and related methods”, the disclosure of which is herein incorporated in its entirety by reference.

As used herein, “catalyst”, or “electrochemical reaction layer” refers to a material or substance (or layer of a material or substance) that assists in starting or increasing the rate of a reaction, without being modified or consumed itself. Catalyst layers may comprise any type of electrocatalyst material suitable for the application at hand. Catalysts or catalyst layers may include pure platinum, carbon-supported platinum, platinum black, platinum-ruthenium, palladium, copper, tin oxide, nickel, gold, mixtures of carbon black, and one or more binders. Binders may include polypropylene, polyethylene, polycarbonate, polyimides, polyamides, fluoropolymers and other polymer films. An example of a polyimide includes Kapton™. An example of a fluoropolymer is PTFE (polytetrafluoroethylene) or Teflon™. Other fluoropolymers include PFSA (perfluorosulfonic acid), FEP (fluorinated ethylene propylene), PEEK (poly ether ether ketones) and PFA (perfluoroalkoxyethylene). The binder may also include PVDF (polyvinylidene difluoride) powder (e.g., Kynar™) and silicon dioxide powder. The binder may include any combination of polymers. The carbon black may include any suitable finely divided carbon material such as one or more of acetylene black carbon, carbon particles, carbon flakes, carbon fibers, carbon needles, carbon nanotubes, and carbon nanoparticles, as further described herein.

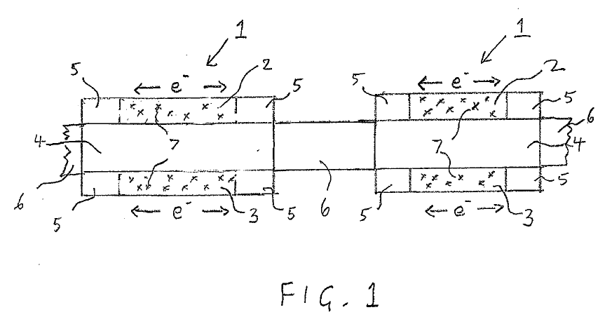

FIG. 1 shows two solid polymer electrolyte fuel cells 1 employed in a fuel cell system having a planar architecture. Fuel cells 1 have electrodes comprising anode catalyst layers 2 and cathode catalyst layers 3 that are disposed on opposite sides of solid polymer electrolyte 4. Current collectors 5 are located at the edge of the anode and cathode catalyst layers 2, 3. The fuel cell system may optionally be mounted on an appropriate planar support or substrate 6. The current flow to and from the reactive catalyst layers is thus in the plane of fuel cells 1 (the direction of current flow, e-, is indicated by arrows in FIG. 1). Current collectors 5 collect current at the edges of the catalyst layers 2, 3 and, depending on how fuel cells 1 are interconnected, transport current to adjacent fuel cells in the system. A plurality of fuel cells 1 may be included and integrated in a series and/or parallel array to make up a micro fuel cell system. The plurality of fuel cells may be electrically connected via suitable cell interconnects (not shown) to make up a desired series and/or parallel configuration.

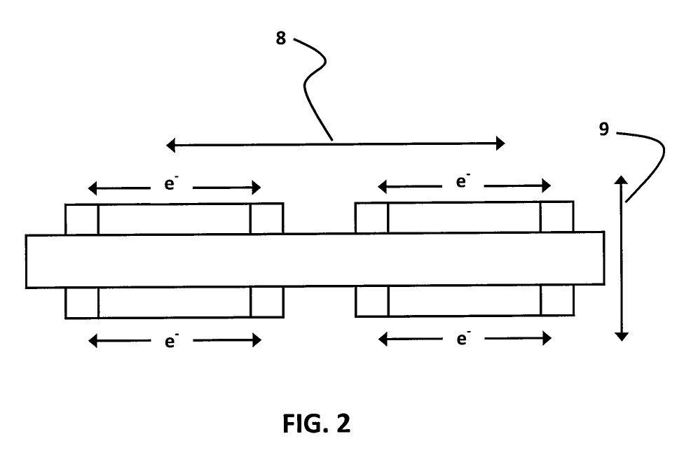

Referring to FIG. 1, the electrolyte 4 may be described as having first and second major surfaces, forming a substantially two-dimensional structure with length and width dimensions parallel to the major surfaces being relatively larger than the thickness of the electrolyte (perpendicular to the major surfaces). Electrodes comprising anode and cathode catalyst layers 2, 3 may be disposed on the first and second major surfaces of the electrolyte, substantially parallel to the major surfaces. As illustrated in FIG. 1, current flow is shown as being generally “in-plane” or parallel to the major surfaces of the electrolyte and electrodes (see element 8 of FIG. 2). For reference, a dimension or direction substantially perpendicular to the major surfaces of the electrolyte and electrodes may be referred to as a “through-plane” direction or dimension (see element 9 of FIG. 2).

The performance of fuel cells 1, and hence of the system overall, is improved by increasing the electrical conductivity of anode and/or cathode catalyst layers 2, 3. Here, this is achieved by incorporating a suitable, highly electrically conductive material 7 in the catalyst layer to lower the resistance in the direction of current flow. It is understood that any of the conductive elements, such as the catalyst layer, the electrode, the current collector, and the cell interconnect, may include highly conductive materials that exhibit lower electrical resistance in the direction of current flow. These highly conductive materials may lower electrical resistance of the catalyst layer relative to a catalyst layer without such highly conductive materials. The highly conductive materials may optionally lower electrical resistance perpendicular to the direction of current flow relative to a catalyst layer without such highly conductive materials, in addition to lowering the electrical resistance parallel to the direction of current flow.

In some embodiments, the electrical conductivity of the anode and/or catalyst layers may be higher, in the in-plane direction (as shown by arrows in FIG. 1, and element 8 in FIG. 2) than in the through-plane direction (substantially perpendicular to the general direction of current flow, illustrated by element 9 in FIG. 2). The relative conductivity may be slightly higher in the in-plane direction, or may be substantially higher in the in-plane direction. Similarly, the electrical resistance of the catalyst layer may be lower in the direction of current flow. First, it may be lower in the direction of current flow relative to a catalyst layer with no highly conductive additive and second, it may be optionally lower relative to a direction perpendicular to the current flow.

The catalyst in layers 2, 3 may be platinum black. As such, the highly conductive material may be selected to exhibit stability against oxidation, be robust to fuel starvation, and to be corrosion tolerant. The catalyst and/or added highly conductive material may be deposited via any suitable deposition technology, such as spray deposition, as one non-limiting example. Deposition techniques may facilitate high resolution of the catalyst and/or the highly conductive material.

Highly conductive materials or additives may include graphite, carbon nanotubes, and corrosion tolerant metals (e.g. gold). Carbon nanotubes may be single-walled carbon nanotubes or multi-walled nanotubes.

A single-walled carbon nanotube is a one-atom thick sheet of graphite (called graphene) rolled up into a seamless cylinder with diameter on the order of a nanometer. This results in a nanostructure where the length-to-diameter ratio may exceed 1,000,000. Such cylindrical carbon molecules have novel properties that make them potentially useful in many applications in nanotechnology, electronics, optics and other fields of materials science. They exhibit extraordinary strength and unique electrical properties, and are efficient conductors of heat. Inorganic nanotubes have also been synthesized.

Most single-walled nanotubes have a diameter of close to 1 nanometer, with a tube length that may be many thousands of times longer. The structure of a single-walled nanotube may be conceptualized by wrapping a graphene sheet into a seamless cylinder. The way the graphene sheet is wrapped is represented by a pair of indices (n,m) called the chiral vector. The integers n and m denote the number of unit vectors along two directions in the honeycomb crystal lattice of graphene. If m=0, the nanotubes are called “zigzag”. If n=m, the nanotubes are called “armchair”. Otherwise, they are called “chiral”.

Single-walled nanotubes are a very important variety of carbon nanotube because they exhibit important electric properties that are not shared by the multi-walled carbon nanotube variants. Single-walled nanotubes are the most likely candidate for miniaturizing electronics beyond the micro electromechanical scale that is currently the basis of modern electronics. The most basic building block of these systems is the electric wire, and single-walled nanotubes may be excellent conductors.

Multi-walled nanotubes consist of multiple layers of graphite rolled in on themselves to form a tube shape. Double-walled carbon nanotubes may combine very similar morphology and properties as compared to single-walled nanotubes, while improving significantly their resistance to chemicals. This is especially important when functionalisation is required, for example the grafting of chemical functions at the surface of the nanotubes, to add new properties thereto. In the case of single-walled nanotubes, covalent functionalisation will break some C═C double bonds, leaving “holes” in the structure on the nanotube and thus modifying both its mechanical and electrical properties. In the case of double-walled nanotubes, only the outer wall is modified.

Other nanotube structures may also be used, such as fullerites, torus, nanobuds, etc. Fullerites are the solid-state manifestation of fullerenes and related compounds and materials. Being highly incompressible nanotube forms, polymerized single-walled nanotubes are a class of fullerites and are comparable to diamond in terms of hardness. However, due to the way that nanotubes intertwine, polymerized single-walled nanotubes don't have the corresponding crystal lattice that makes it possible to cut diamonds neatly. This same structure results in a less brittle material, as any impact that the structure sustains is spread out throughout the material. A nanotorus is a theoretically described carbon nanotube bent into a torus (doughnut shape). Properties such as magnetic moment, thermal stability, etc. vary widely depending on radius of the torus and radius of the tube. Carbon nanobuds are a newly discovered material combining two previously discovered allotropes of carbon: carbon nanotubes and fullerenes. In this new material, fullerene-like “buds” are covalently bonded to the outer sidewalls of an underlying carbon nanotube. This hybrid material has useful properties of both fullerenes and carbon nanotubes. In particular, they have been found to be exceptionally good field emitters.

Because of the symmetry and unique electronic structure of graphene, the structure of a nanotube strongly affects its electrical properties. For a given (n,m) nanotube, if n−m is a multiple of 3, then the nanotube is metallic, otherwise the nanotube is a semiconductor. Thus all armchair (n=m) nanotubes are metallic, and nanotubes (5,0), (6,4), (9,1), etc. are semiconducting. Metallic nanotubes may have an electrical current density more than 1,000 times greater than metals such as silver and copper.

Various methods of operating the fuel cell or fuel cell system may be used to alter properties of the incorporated highly conductive material. For example, the flow of water through carbon nanotube membranes (without filler matrix, thus flow is on the outside surface of carbon nanotubes) may be precisely controlled through the application of electrical current. Nanotube membranes are films composed of open-ended nanotubes that are oriented perpendicularly to the surface of an impermeable film matrix like the cells of a honeycomb. Fluids and gas molecules may pass through the membrane en masse. Water may pass through the graphitic nanotube cores of the membrane at speeds several magnitudes greater than classical fluid dynamics would predict.

Embodiments of the invention also related to a method for improving the performance of a planar fuel cell system, including incorporating a highly electrically conductive additive into at least one of anode and cathode catalyst layers, sufficient to reduce ohmic losses in a fuel cell system. The method may include reducing ohmic losses in the fuel cell system by reducing the electrical resistivity of the catalyst layer, and may further include reducing the in-plane resistivity of the catalyst layer. The ohmic losses may be reduced by the addition of a highly conductive material to the catalyst layer. The highly conductive material may include graphite, carbon nanotubes, corrosion tolerant metals, or combinations thereof.

What is claimed is:

1. A planar fuel cell system comprising:
a plurality of solid polymer electrolyte fuel cells arranged in a planar architecture, each fuel cell comprising
an anode electrode,
a cathode electrode, and
a solid polymer electrolyte, each electrode comprising a catalyst layer; and
current collectors coupled to at least one edge of an electrode,
wherein at least one of the anode and cathode catalyst layers comprises a highly electrically conductive additive.

2. The planar fuel cell system of claim 1, wherein the highly electrically conductive additive comprises graphite, carbon nanotubes, corrosion tolerant metals, or combinations thereof.

3. The planar fuel cell system of claim 2 wherein the carbon nanotube additive is a single wall nanotube, a nanotube membrane, or a multiwall nanotube.

4. The planar fuel cell system of claim 2 wherein the corrosion tolerant metal additive is gold.

5. The planar fuel cell system of claim 1, wherein the highly electrically conductive additive is adapted to provide higher electrical conductivity in an in-plane direction relative to a through-plane direction.

6. The planar fuel cell system of claim 1, wherein a resistance of at least one of the catalyst layers in a direction parallel to the plane of the electrode is lower than a resistance of the catalyst layers in a direction perpendicular to the plane of the electrode.

7. The planar fuel cell system of claim 1, wherein the highly conductive additive in one electrode is coupled to one of the corresponding current collectors adjacent to the electrode.

8. A method for improving the performance of a planar fuel cell system, comprising:
incorporating a highly electrically conductive additive into at least one of anode and cathode catalyst layers, sufficient to reduce ohmic losses in a fuel cell system; the fuel cell system comprising,
a plurality of solid polymer electrolyte fuel cells arranged in a planar architecture, each fuel cell comprising
an anode electrode,
a cathode electrode, and
a solid polymer electrolyte, each electrode comprising a catalyst layer; and
current collectors coupled to the edge of the electrodes.

9. The method of claim 8, wherein the highly electrically conductive additive comprises graphite, carbon nanotubes, corrosion tolerant metals, or combinations thereof.

10. The method of claim 8, wherein ohmic losses in the fuel cell system comprise electrical resistivity of the catalyst layer.

11. The method of claim 10, wherein the electrical resistivity of the catalyst layer comprises the electrical resistivity in an in-plane direction parallel relative to the electrodes.
